(19) United States
(12) Patent Application Publication
(10) Pub. No.: US 2026/0270844 A1
(43) Pub. Date: Sep. 10, 2026

(54) ANCHOR LINK DESIGN FOR MLO OPERATION IN WLANS

(71) Applicant: Samsung Electronics Co., Ltd., Suwon-si (KR)

(72) Inventors: Peshal Nayak, Plano, TX (US); Bilal Sadiq, Plano, TX (US); Rubayet Shafin, Frisco, TX (US); Vishnu Vardhan Ratnam, Frisco, TX (US); Yue Qi, Plano, TX (US); Boon Loong Ng, Plano, TX (US)

(21) Appl. No.: 19/544,860

(22) Filed: Feb. 19, 2026

Related U.S. Application Data
(60) Provisional application No. 63/766,771, filed on Mar. 4, 2025.
(60) Provisional application No. 63/782,342, filed on Apr. 2, 2025.
(60) Provisional application No. 63/785,436, filed on Apr. 8, 2025.

(51) Int. Cl. H04W 40/24; H04W 84/12

(52) U.S. Cl. CPC H04W 40/248; H04W 84/12

(57) ABSTRACT

Methods and apparatuses for anchor link design for multi-link operation in wireless local area networks (WLANS). A method performed by an access point (AP) multi-link device (MLD) includes forming a millimeter wave (mmWave) link with a non-AP MLD for transmission of data between the AP MLD and the non-AP MLD. The method includes forming an anchor link with the non-AP MLD for transmission of information corresponding to the mm Wave link. The method further includes transmitting, to the non-AP MLD, the information corresponding to the mm Wave link on the anchor link.

### CROSS-REFERENCE TO RELATED APPLICATION(S) AND CLAIM OF PRIORITY

This application claims priority under 35 U.S.C. § 119(e) to U.S. Provisional Patent Application No. 63/766,771, filed on Mar. 4, 2025, U.S. Provisional Patent Application No. 63/782,342, filed on Apr. 2, 2025, and U.S. Provisional Patent Application No. 63/785,436, filed on Apr. 8, 2025. The above identified provisional patent applications are hereby incorporated by reference in their entirety.

### TECHNICAL FIELD

This disclosure relates generally to wireless communication, and more specifically to anchor link design for multi-link operation in wireless local area networks (WLANS).

### BACKGROUND

Wireless Local Area Network (WLAN) technology allows devices to access the internet in the 2.4 GHZ, 5 GHZ, 6 GHz or 60 GHz frequency bands. WLANs are based on the Institute of Electrical and Electronic Engineers (IEEE) 802.11 standards. IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax, etc.

### SUMMARY

Embodiments of the present disclosure provide methods and apparatuses for anchor link design for multi-link operation in WLANS.

In one embodiment, a method performed by an access point (AP) multi-link device (MLD) includes forming a millimeter wave (mmWave) link with a non-AP MLD for transmission of data between the AP MLD and the non-AP MLD. The method includes forming an anchor link with the non-AP MLD for transmission of information corresponding to the mmWave link. The method further includes transmitting, to the non-AP MLD, the information corresponding to the mmWave link on the anchor link.

In another embodiment, an electronic device comprises at least one processor including processing circuitry, and memory storing instructions. The instructions, when executed by the at least one processor individually or collectively, cause the electronic device to form a mmWave link with a non-AP MLD for transmission of data between an AP MLD and the non-AP MLD. The instructions, when executed by the at least one processor individually or collectively, cause the electronic device to form an anchor link with the non-AP MLD for transmission of information corresponding to the mmWave link. The instructions, when executed by the at least one processor individually or collectively, cause the electronic device to transmit, to the non-AP MLD, the information corresponding to the mm Wave link on the anchor link.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2A illustrates an example access point (AP) according to embodiments of the present disclosure;

FIG. 2B illustrates an example station (STA) according to embodiments of the present disclosure;

FIG. 3 illustrates an example of an anchor link/reference link setup according to embodiments of the present disclosure;

FIG. 4 illustrates an example procedure for integrated millimeter (mm) wave operation according to embodiments of the present disclosure;

FIG. 5 illustrates an example procedure for anchor link/reference link operation according to embodiments of the present disclosure;

FIG. 6 illustrates an example procedure for non-anchor link/reference link operation according to embodiments of the present disclosure;

FIG. 7 illustrates example signaling for multiple anchor link/reference link indication according to embodiments of the present disclosure;

FIG. 8 illustrates example signaling for a single anchor link/reference link indication according to embodiments of the present disclosure;

FIG. 9 illustrates example signaling for an anchor link/reference link indication according to embodiments of the present disclosure;

FIG. 10 illustrates example signaling for an anchor link/reference link present indication according to embodiments of the present disclosure;

FIG. 11 illustrates another example signaling for an anchor link/reference link present indication according to embodiments of the present disclosure;

FIG. 12 illustrates an example signaling for an anchor link/reference link indication in the reference link's per-STA profile according to embodiments of the present disclosure;

FIG. 13 illustrates an example signaling for an indication of an integrated mmWave link according to embodiments of the present disclosure;

FIG. 14 illustrates an example element to advertise a connectivity threshold according to embodiments of the present disclosure;

FIG. 15 illustrates another example element to advertise a connectivity threshold for various links according to embodiments of the present disclosure;

FIG. 16 illustrates an example format for a link ID-threshold pair according to embodiments of the present disclosure;

FIG. 17 illustrates an example operation of MLDS according to embodiments of the present disclosure; and

FIG. 18 illustrates an example method performed by an access point (AP) multi-link device (MLD) in a wireless communication system according to embodiments of the present disclosure.

### DETAILED DESCRIPTION

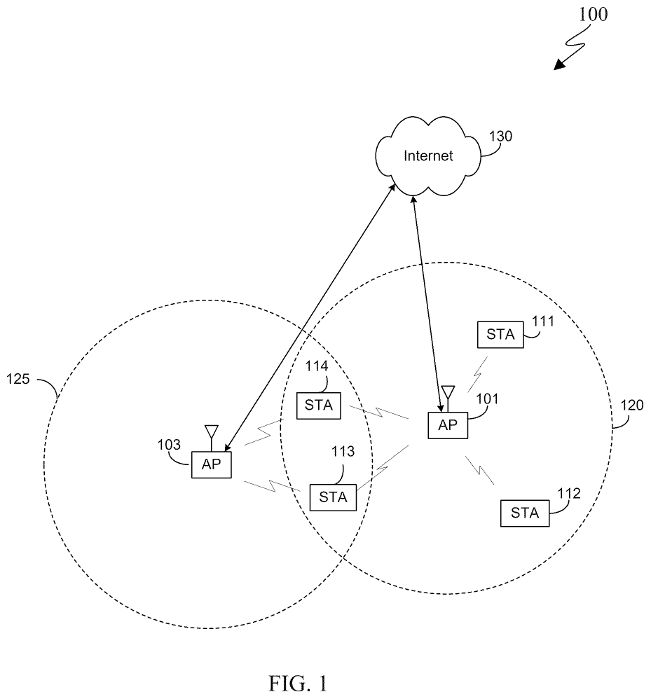

FIGS. 1 through 19, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents and standards descriptions are hereby incorporated by reference into the present disclosure as if fully set forth herein: [1] IEEE P802.11be/D7.0, 2024.

Existing WLAN standards support multiple bands of operation, where an access point (AP) and a non-AP device may communicate with each other, called links. Thus, both the AP and non-AP device may be capable of communicating on different bands/links, which is referred to as multi-link operation (MLO). Devices capable of such MLO are referred to as multi-link devices (MLDs).

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for facilitating anchor link design for multi-link operation in WLANS. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

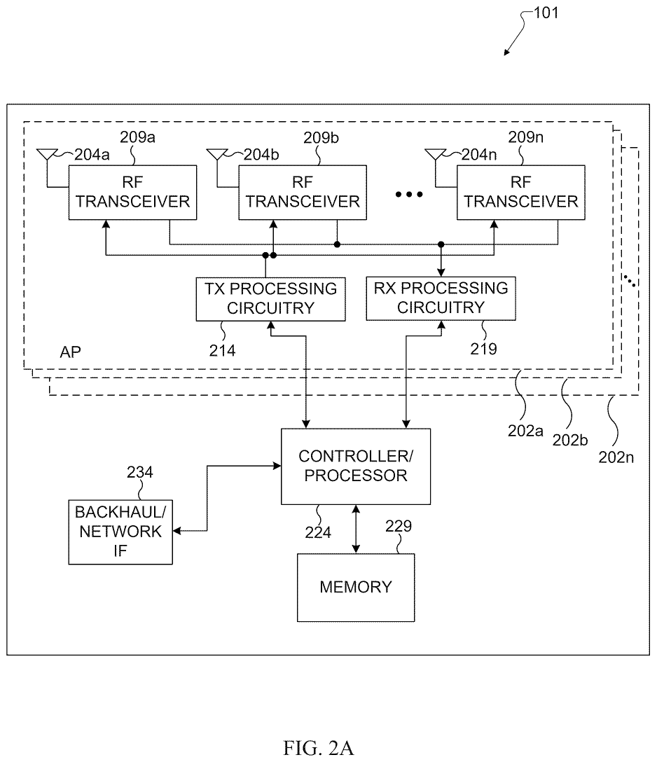

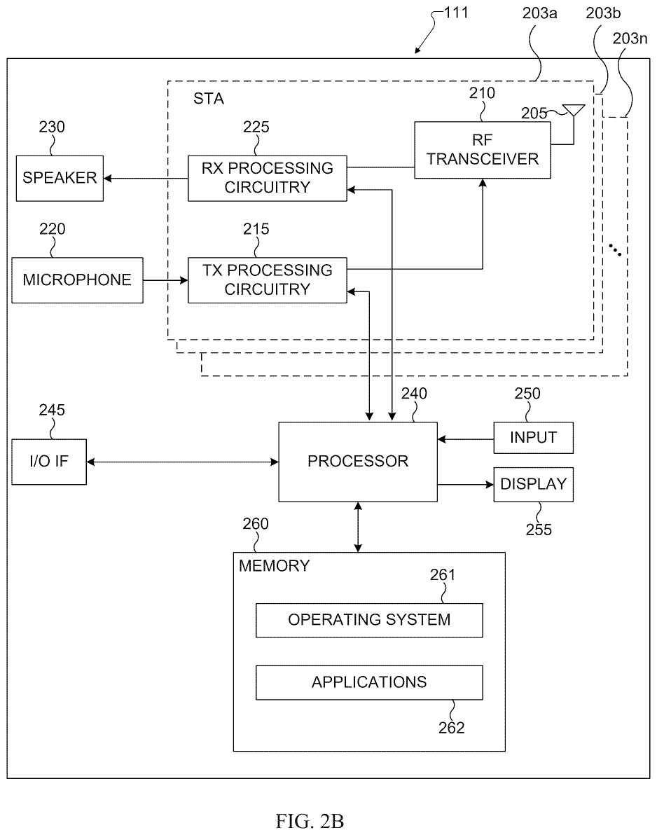

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. In the embodiments discussed below, the AP 101 is an AP MLD. However, APs come in a wide variety of configurations, and FIG. 2A does not limit the scope of this disclosure to any particular implementation of an AP.

The AP MLD 101 is affiliated with multiple APs 202a-202n (which may be referred to, for example, as AP1-APn). Each of the affiliated APs 202a-202n includes multiple antennas 204a-204n, multiple RF transceivers 209a-209n, transmit (TX) processing circuitry 214, and receive (RX) processing circuitry 219. The AP MLD 101 also includes a controller/processor 224, a memory 229, and a backhaul or network interface 234.

The illustrated components of each affiliated AP 202a-202n may represent a physical (PHY) layer and a lower media access control (LMAC) layer in the open systems interconnection (OSI) networking model. In such embodiments, the illustrated components of the AP MLD 101 represent a single upper MAC (UMAC) layer and other higher layers in the OSI model, which are shared by all of the affiliated APs 202a-202n.

For each affiliated AP 202a-202n, the RF transceivers 209a-209n receive, from the antennas 204a-204n, incoming RF signals, such as signals transmitted by STAs in the network 100. In some embodiments, each affiliated AP 202a-202n operates at a different bandwidth, e.g., 2.4 GHz, 5 GHZ, or 6 GHZ, and accordingly the incoming RF signals received by each affiliated AP may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP 202a-202n operates at a different bandwidth, e.g., 2.4 GHz, 5 GHZ, or 6 GHz, the outgoing RF signals transmitted by each affiliated AP may be at a different frequency of RF.

The controller/processor 224 can include one or more processors or other processing devices that control the overall operation of the AP MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support orthogonal frequency division multiple access (OFDMA) operations in which outgoing signals are assigned to different subsets of subcarriers for different recipients (e.g., different STAs 111-114). Any of a wide variety of other functions could be supported in the AP MLD 101 by the controller/processor 224 including anchor link design for multi-link operation. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP MLD 101 to communicate with other devices or systems over a backhaul connection or over a network. The interface 234 could support communications over any suitable wired or wireless connection(s). For example, the interface 234 could allow the AP MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP MLD 101 may include circuitry and/or programming for facilitating anchor link design for multi-link operation in WLANS. Although FIG. 2A illustrates one example of AP MLD 101, various changes may be made to FIG. 2A. For example, the AP MLD 101 could include any number of each component shown in FIG. 2A. As a particular example, an AP MLD 101 could include a number of interfaces 234, and the controller/processor 224 could support routing functions to route data between different network addresses. As another particular example, while each affiliated AP 202a-202n is shown as including a single instance of TX processing circuitry 214 and a single instance of RX processing circuitry 219, the AP MLD 101 could include multiple instances of each (such as one per RF transceiver) in one or more of the affiliated APs 202a-202n. Alternatively, only one antenna and RF transceiver path may be included in one or more of the affiliated APs 202a-202n, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In the embodiments discussed below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antenna(s) 205, a radio frequency (RF) transceiver 210, TX processing circuitry 215, and receive (RX) processing circuitry 225. The non-AP MLD 111 also includes a microphone 220, a speaker 230, a processor 240, an input/output (I/O) interface (IF) 245, an input 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives from the antenna(s) 205, an incoming RF signal transmitted by an AP of the network 100. In some embodiments, each affiliated STA 203a-203n operates at a different bandwidth, e.g., 2.4 GHz, 5 GHZ, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205. In embodiments wherein each affiliated STA 203a-203n operates at a different bandwidth, e.g., 2.4 GHz, 5 GHZ, or 6 GHZ, the outgoing RF signals transmitted by each affiliated STA may be at a different frequency of RF.

The processor 240 can include one or more processors and execute the basic OS program 261 stored in the memory 260 in order to control the overall operation of the non-AP MLD 111. In one such operation, the processor 240 controls the reception of forward channel signals and the transmission of reverse channel signals by the RF transceiver 210, the RX processing circuitry 225, and the TX processing circuitry 215 in accordance with well-known principles. The processor 240 can also include processing circuitry configured to facilitate anchor link design for multi-link operation in WLANS. In some embodiments, the processor 240 includes at least one microprocessor or microcontroller.

The processor 240 is also capable of executing other processes and programs resident in the memory 260, such as operations for facilitating anchor link design for multi-link operation in WLANS. The processor 240 can move data into or out of the memory 260 as required by an executing process. In some embodiments, the processor 240 is configured to execute a plurality of applications 262, such as applications for facilitating anchor link design for multi-link operation in WLANS. The processor 240 can operate the plurality of applications 262 based on the OS program 261 or in response to a signal received from an AP. The processor 240 is also coupled to the I/O interface 245, which provides non-AP MLD 111 with the ability to connect to other devices such as laptop computers and handheld computers. The I/O interface 245 is the communication path between these accessories and the processor 240.

The processor 240 is also coupled to the input 250 and the display 255. The operator of the non-AP MLD 111 can use the input 250 to enter data into the non-AP MLD 111. The display 255 may be a liquid crystal display, light emitting diode display, or other display capable of rendering text and/or at least limited graphics, such as from web sites. The memory 260 is coupled to the processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted, and additional components could be added according to particular needs. In particular examples, one or more of the affiliated STAs 203a-203n may include any number of antenna(s) 205 for MIMO communication with an AP 101. In another example, the non-AP MLD 111 may not include voice communication or the processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

Embodiments of the present disclosure recognize that emerging applications such as XR, gaming, etc. often have a high throughput/stringent low latency requirement. mmWave band provides many opportunities for enhancing the performance of such applications. Typically, there is abundant spectrum available in the mmWave bands of operation. Further, the directional transmission also provides an opportunity for reducing interference and increasing spatial reuse. In the past, mm Wave operation in Wi-Fi was driven by 802.11ad and ay amendments. However, such designs propose independent architectures for mmWave operation. To minimize the complexity and cost while providing mmWave support, next generation WLANs can have an architecture in which a mm Wave link can be integrated as an add-on to a multi-link device (MLD). Thus, mmWave can function as an additional link (in addition to existing sub-6 GHz/sub-7.25 GHz links) in MLDs.

Embodiments of the present disclosure further recognize that in 802.11be, a new architecture was introduced based on multi-link operation (MLO). MLO operation defined a new architectural entity called MLD. An MLD can have one or more STAs affiliated with it. These STAs are called STAs affiliated with an MLD, and they can be co-located on the same physical device. The affiliated STAs can either be AP STAs or non-AP STAs. Information on each affiliated AP STAs can be advertised by an AP MLD in management frames such as beacons, probe responses, etc. transmitted by these affiliated AP STAs.

In next generation WLANs, to reduce power consumption from mmWave operation, it can be desired to reduce/limit the usage of a mmWave link to only certain types of frames. As an example, the mmWave operation can be primarily used for transmission of data frames and other types of frames such as management frames can be exchanged on one of the sub-6 GHz/sub-7.25 GHz link. Thus, frames such as beacons may be transmitted in a shorter form compared to the sub-6/sub-7.25 GHz limiting the information exchange in a beacon or they may not be transmitted at all on the mmWave link and instead the information can be transmitted on a sub-6 GHz/sub-7.25 GHz link. In this disclosure, the frames which are not allowed/have any usage limitations on the mmWave links are referred to as restricted frames and their content is referred to as restricted frame information.

An AP MLD can have up to 16 links. However, non-AP MLDs may have a far smaller number of links depending on their configurations, hardware limitations, size and cost constraints, etc. Further, different non-AP MLDs can form different links with an AP MLD i.e., two non-AP MLDs may not have a common link with the AP MLD. If restricted frame information is transmitted on each sub-6/sub-7.25 GHz link of an MLD, this can result in an increased overhead for the sub-6/sub-7.25 GHz links. Thus, a solution is needed to handle the restricted frame information in MLDs which have an integrated mmWave link.

When a non-AP MLD has a mmWave link in multi-link operation (MLO), the mmWave link can have a range and connectivity characteristics which can be significantly different from that of the sub-6 GHz link. Consequently, a non-AP MLD may not know when to add a mmWave link for ML operation. A procedure and signaling is needed to address this issue.

Accordingly, the present disclosure provides a number of solutions for handling restricted frame information exchange for integrated mmWave operation. Aspects include:
1. Reference link/Anchor link design
2. Modification to the link setup procedure
3. Modification to the link add procedure
4. Reference link advertisement
5. Example signaling
6. Capability advertisement

The present disclosure further provides a number of solutions for handling connectivity threshold advertisement for integrated mmWave operation in multi-link design. Aspects include:
1. Connectivity metric
2. AP side measurement and assistance
3. Non-STA side measurement
4. Advertisement of the connectivity threshold
5. Advertisement of the connectivity threshold for a neighbor AP
6. Example operation

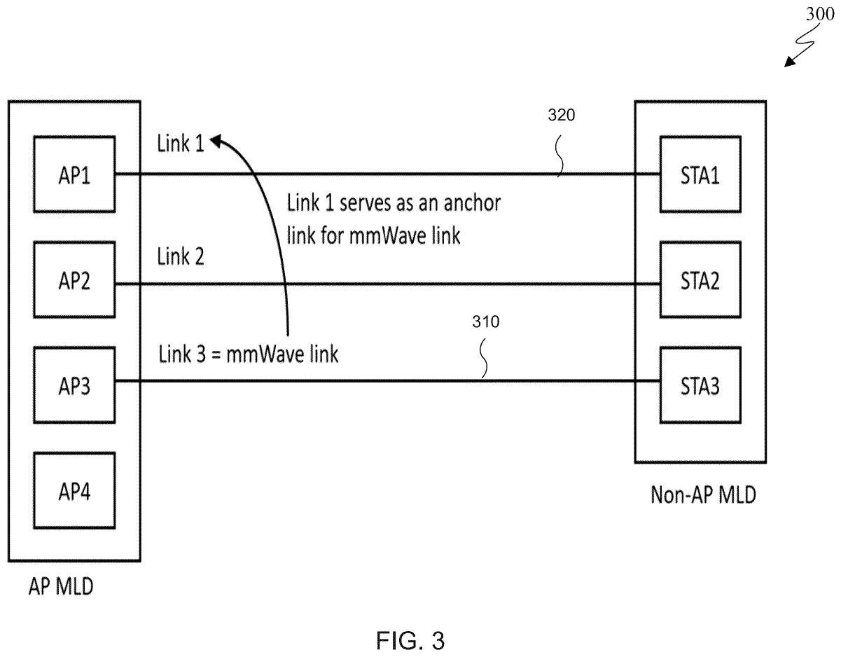

FIG. 3 illustrates an example of an anchor link/reference link setup 300 according to embodiments of the present disclosure. The embodiment of an anchor link/reference link setup of FIG. 3 is for illustration only. Different embodiments of an anchor link/reference link setup could be used without departing from the scope of this disclosure.

According to one embodiment, MLDs that have an integrated mmWave can have at least one link for exchange of restricted frame information. This link can be referred to as an anchor link/reference link in this disclosure. As shown in FIG. 3, link 3 310 is a mmWave link, and link 1 320 can serve as an anchor link for the mmWave link.

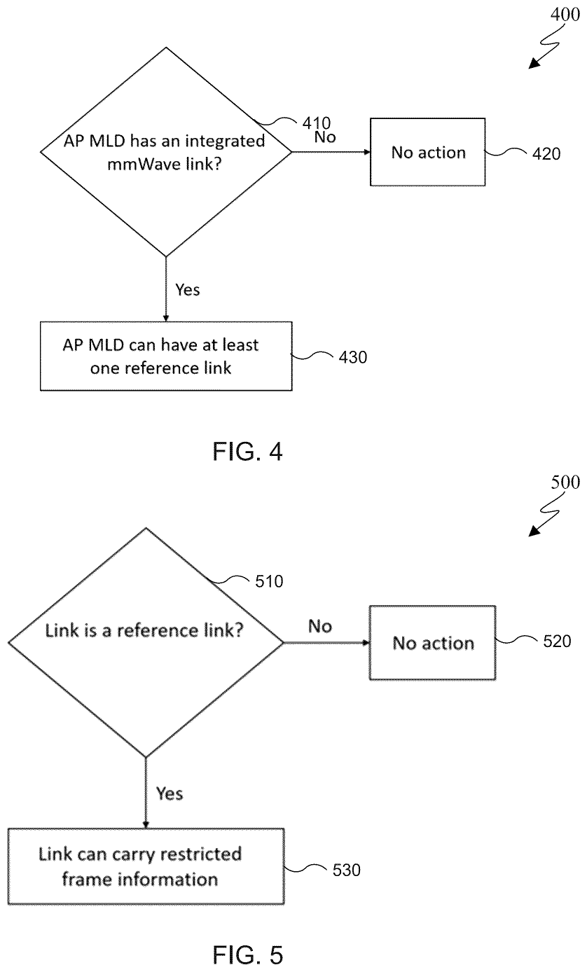

FIG. 4 illustrates an example procedure 400 for integrated millimeter (mm) wave operation according to embodiments of the present disclosure. The embodiment of an example procedure for integrated mmWave operation of FIG. 4 is for illustration only. Different embodiments of an example procedure for integrated mmWave operation could be used without departing from the scope of this disclosure.

As shown in FIG. 4, the procedure 400 begins at step 410, where a determination is made whether an AP MLD has an integrated mmWave link. If the AP MLD does not have an integrated mmWave link, then at step 420 no action is taken. If the AP MLD has an integrated mmWave link, then at step 430 the AP MLD can have at least one reference link.

According to one embodiment, an AP MLD can transmit restricted frame information on an anchor link/reference link. A link that is not an anchor/reference may not be used for transmission of restricted frame information.

FIG. 5 illustrates an example procedure 500 for anchor link/reference link operation according to embodiments of the present disclosure. The embodiment of an example procedure for anchor link/reference link operation of FIG. 5 is for illustration only. Different embodiments of an example procedure for anchor link/reference link operation could be used without departing from the scope of this disclosure.

As shown in FIG. 5, the procedure 500 begins at step 510, where a determination is made whether a link is a reference link. If the link is not a reference link, then at step 520 no action is taken. If the link is a reference link, then at step 530 the link can carry restricted frame information.

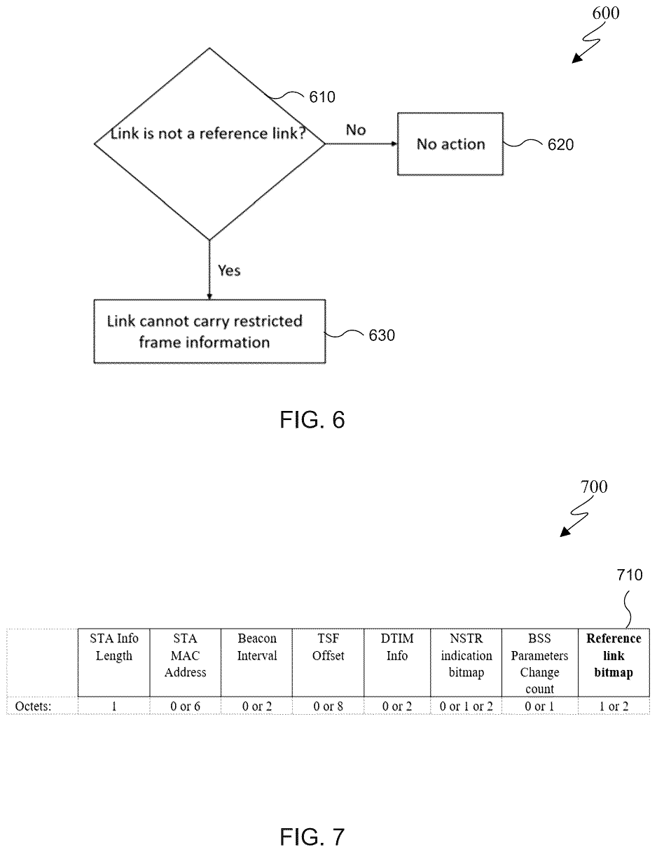

FIG. 6 illustrates an example procedure 600 for non-anchor link/reference link operation according to embodiments of the present disclosure. The embodiment of an example procedure for non-anchor link/reference link operation of FIG. 6 is for illustration only. Different embodiments of an example procedure for non-anchor link/reference link operation could be used without departing from the scope of this disclosure.

As shown in FIG. 6, the procedure 600 begins at step 610, where a determination is made whether a link is not a reference link. If no, then at step 620 no action is taken. If yes, then at step 630 the link cannot carry restricted frame information.

According to one embodiment, an AP MLD can have a single reference link.

According to another embodiment, an AP MLD can have multiple reference links.

A non-AP MLD that intends to use the integrated mmWave link of an AP MLD can also form a connection to the AP MLD on the reference link. Thus, the restricted frame information can be received by the non-AP MLD via the reference link.

According to one embodiment, there can be a set of reference links for each mmWave link of an AP MLD.

According to another embodiment, there can be a set of reference links that can be used for all the mmWave links of an AP MLD.

According to one embodiment, some mmWave link(s) can have reference link(s) and some others may not have reference link(s).

According to one embodiment, an AP MLD can maintain a single anchor link for all the associated non-AP MLDs. Any non-AP MLD that wants to use mm Wave link can connect on the single anchor link.

According to another embodiment, an AP MLD can maintain one anchor link that is non-AP MLD specific. According to this embodiment, the AP MLD can configure one link of the non-AP MLD's links as an anchor link. According to another embodiment, the non-AP MLD can choose one out of a candidate anchor link list.

According to another embodiment, multiple of the sub-7.25 GHz links can serve as an anchor.

According to one embodiment, when associating with an AP MLD, if a non-AP MLD requests to setup a mmWave link to be setup along with other links, the AP MLD can verify if at least one of the other links the non-AP MLD has requested to be setup is a reference link. For instance, this can be done by verifying that the basic multi-link element in the (re)association request frame indicates the non-AP MLD's intention to add a reference link (e.g., by including the per-STA profile of the reference link).

If this condition is satisfied, then AP MLD can accept the setup of the mmWave link.

If this condition is not satisfied, the AP MLD can reject the setup of the mm Wave link.

According to one embodiment, when a non-AP MLD intends to add a new link of the AP MLD that it is associated with and if this new link is a mmWave link, then the non-AP MLD can add at least one reference link along with or prior to adding the mmWave link. If the AP receives a request from the non-AP MLD for a multi-link (ML) reconfiguration and if the request frame does not carry an indication to add at least a reference link while indicating to add a mmWave link, then the AP MLD can reject the request to add the mm Wave link.

According to another embodiment, if an AP MLD receives a request frame the non-AP MLD for a ML reconfiguration and if the request frame carries an indication to add at least a reference link while indicating to add a mmWave link, then the AP MLD can accept the request to add the mmWave link.

According to one embodiment, the AP can transmit an advertisement message to advertise the reference link(s).

The advertisement message can contain at least one or more of the information items as shown in Table 1.

TABLE 1
Information items that can be present in an advertisement message

| Information | |
|---|---|
| items | Description |
| Reference | At least one or more information items that can identify the reference |
| link(s) identifier | link(s). For example, link ID, per-STA profile of the corresponding link, |
| | etc. |
| Reference | At least one or more information items that can indicate that the |
| link(s) | identified link is a reference link for the integrated mmWave link(s). |
| indication | |
| Integrated | At least one or more information items that can indicate the mmWave |
| mmWave link | link for which the link can act as a reference link. This can be useful in |
| indication | cases wherein there are more than on mmWave link and each link can |
| | have a separate set of reference links. |

The above information can be carried in any frame/field/subfield in the standard or in newly defined frames/fields/subfields in the standard. They can be carried in the same frames or spread/duplicated across multiple frames.

FIG. 7 illustrates example signaling for multiple anchor link/reference link indication 700 according to embodiments of the present disclosure. The embodiment of an example signaling for multiple anchor link/reference link indication of FIG. 7 is for illustration only. Different embodiments of an example signaling for multiple anchor link/reference link indication could be used without departing from the scope of this disclosure.

As shown in FIG. 7, according to one embodiment, the STA info field of an integrated mmWave link can carry a reference link ID indication. The modified STA info field can be as shown in the figure below.

The reference link bitmap 710 can carry an indication of the reference links corresponding to the mmWave link. A bit value of 1 in the ith position of the bitmap can indicate that the link with link ID equal to i can act as a reference link for the integrated mm Wave link. A bit value of 0 in the ith position of the bitmap can indicate that the link with link ID equal to i cannot act as a reference link for the integrated mm Wave link.

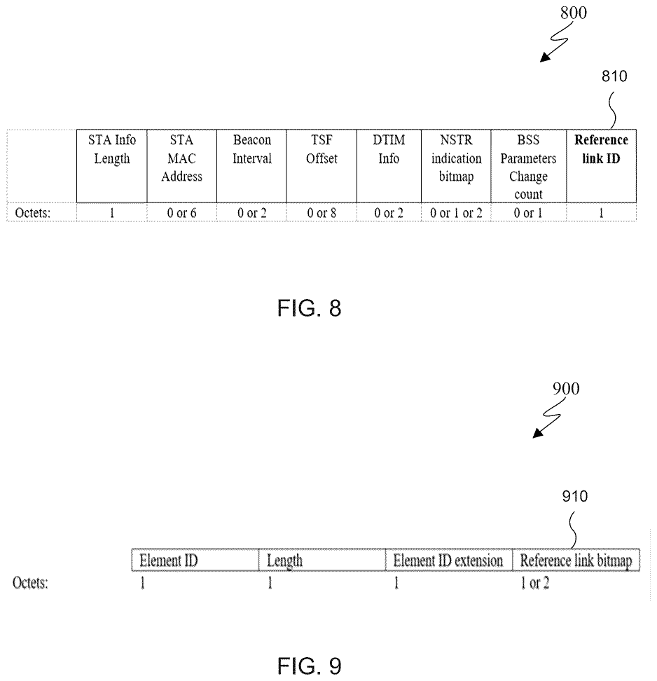

FIG. 8 illustrates example signaling for a single anchor link/reference link indication 800 according to embodiments of the present disclosure. The embodiment of an example signaling for a single anchor link/reference link indication of FIG. 8 is for illustration only. Different embodiments of an example signaling for a single anchor link/reference link indication could be used without departing from the scope of this disclosure.

According to another embodiment, if only one reference link is setup by an AP MLD, then an example indication can be as shown in FIG. 8.

According to one embodiment, the reference link ID field 810 can carry an indication of the link ID of the reference link. Some bits of the field which are not needed for the link ID representation can be kept reserved.

FIG. 9 illustrates example signaling for an anchor link/reference link indication 900 according to embodiments of the present disclosure. The embodiment of an example signaling for an anchor link/reference link indication of FIG. 9 is for illustration only. Different embodiments of an example signaling for an anchor link/reference link indication could be used without departing from the scope of this disclosure.

According to one embodiment, there can be an element which can carry the indication of the reference links.

The reference link bitmap 910 can carry an indication of the reference links corresponding to the mmWave link. A bit value of 1 in the ith position of the bitmap can indicate that the link with link ID equal to i can act as a reference link for the integrated mm Wave link. A bit value of 0 in the ith position of the bitmap can indicate that the link with link ID equal to i cannot act as a reference link for the integrated mmWave link.

The element can be carried in the STA profile of a per-STA profile sub-element.

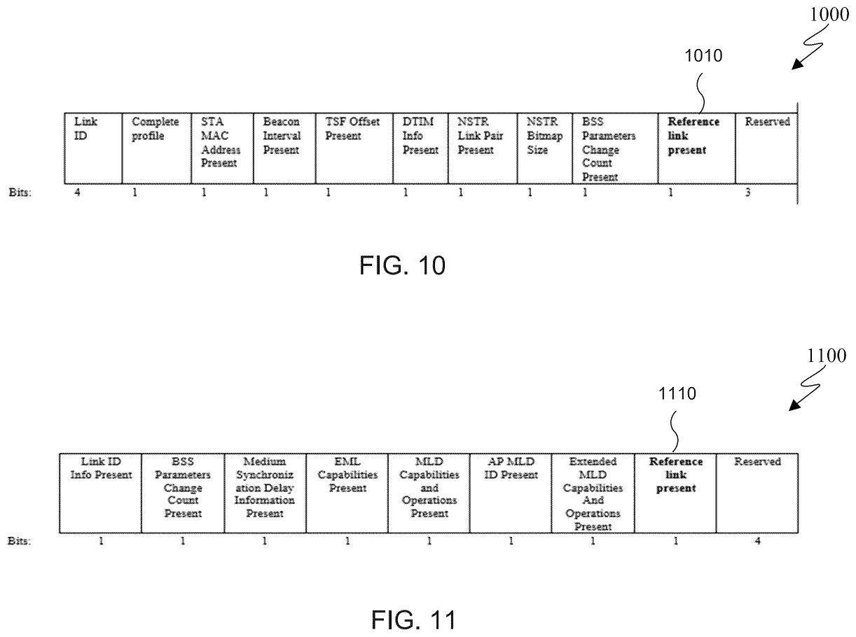

FIG. 10 illustrates example signaling for an anchor link/reference link present indication 1000 according to embodiments of the present disclosure. The embodiment of an example signaling for an anchor link/reference link present indication of FIG. 10 is for illustration only. Different embodiments of an example signaling for an anchor link/reference link indication present could be used without departing from the scope of this disclosure.

According to one embodiment, if an integrated mmWave link has a reference link, then there can be an indication to convey to the non-AP MLD that there is a reference link corresponding to this integrated mm Wave link.

According to one embodiment, a reserved bit 1010 of the STA control filed can carry the indication that a reference link is used for the integrated mmWave link.

FIG. 11 illustrates another example signaling for an anchor link/reference link present indication 1100 according to embodiments of the present disclosure. The embodiment of an example signaling for an anchor link/reference link present indication of FIG. 11 is for illustration only. Different embodiments of an example signaling for an anchor link/reference link indication present could be used without departing from the scope of this disclosure.

According to another embodiment, the presence bitmap subfield can indicate if a reference link is present or not.

The reference link present bit 1110 can be set to a value of 1 to indicate that the reference link is present for the integrated mm Wave link and to a value of 0 to indicate otherwise.

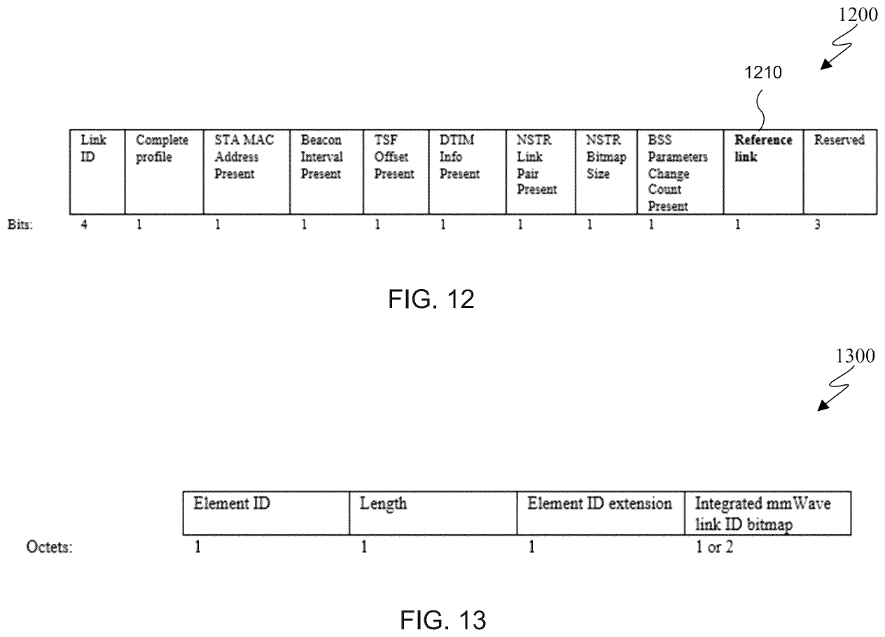

FIG. 12 illustrates an example signaling for an anchor link/reference link indication in the reference link's per-STA profile 1200 according to embodiments of the present disclosure. The embodiment of an example signaling for an anchor link/reference link indication in the reference link's per-STA profile of FIG. 12 is for illustration only. Different embodiments of an example signaling for an anchor link/reference link indication in the reference link's per-STA profile could be used without departing from the scope of this disclosure.

According to one embodiment, the per-STA profile of the reference link can carry an indication of whether it can act as a reference link for the integrated mmWave link or not. According to one example, the STA control field of the per-STA profile sub-element corresponding to a reference link 1210 can carry the indication that the link is a reference link.

If the reference link bit is set to a value of 1, it can indicate that the link to which the STA profile corresponds to can act as a reference for an integrated mm Wave. If the reference link bit is set to a value of 0, it can indicate that it cannot act as a reference link.

FIG. 13 illustrates an example signaling for an indication of an integrated mmWave link 1300 according to embodiments of the present disclosure. The embodiment of an example signaling for an indication of an integrated mmWave link of FIG. 13 is for illustration only. Different embodiments of an example signaling for an indication of an integrated mmWave link could be used without departing from the scope of this disclosure.

According to one embodiment, when a link acts as a reference link for an integrated mm Wave link, it can indicate the integrated mmWave link for which it can act as a reference link. An example indication can be by including an element carrying the indication in the STA profile of a per-STA profile sub-element of the reference link.

A value of 1 in the bit position i of the integrated mmWave link ID bitmap can indicate that the link can act as a reference link for the integrated mmWave link with a link ID equal to i. A value of 0 in the bit position i of the integrated mm Wave link ID bitmap can indicate that the link cannot act as a reference link for the link with link ID equal to i.

Instead of a link ID bitmap, there can also be a single link ID field which can be 1 octet and can use 4 bits to indicate the link ID, and the remaining 4 bits can be reserved.

According to one embodiment, the AP MLD can insert an element (e.g., a capabilities element for non-standalone mmWave operation) into its frames. This element can be inserted into the per-STA profile corresponding to a given link. Based on this inference, the non-AP MLD can infer that the particular link can serve as an anchor link.

The above advertisements of mm Wave link can be made by the AP MLD to the entire BSS or just to a particular non-AP MLD. For example, in (Re) association responses, probe responses, etc.

According to one embodiment, an AP MLD that can support integrated mm Wave link can advertise the capability in management frames that it transmits. A non-AP MLD can receive the advertisement and understand that the AP MLD can support integrated mm Wave link and can look for the reference link indications.

According to one embodiment, a non-AP MLD that can support integrated mmWave link can advertise the capability in management frames that it transmits. An AP MLD that receives such an indication can understand the support on the non-AP MLD side.

According to one embodiment, a connectivity metric can be considered. According to this embodiment, the connectivity metric can be measured on another link besides the mmWave link that can be setup with an AP MLD.

According to another embodiment, the connectivity metric can be relative to the mmWave link itself.

By comparing the connectivity metric's value to a threshold, a determination can be made on whether the mmWave link can be established between a non-AP MLD and an AP MLD.

Examples of connectivity metrics can be as shown in Table 2.

TABLE 2
Examples of connectivity metrics

| Connectivity | |
|---|---|
| metric | Description |
| RSSI | According to one embodiment, this can be a RSSI measurement on a sub- |
| | 6 GHz link. So, if the sub-6 GHz link has a strong RSSI, then the non-AP |
| | MLD can determine that it can be within the connectivity range for the |
| | mmWave link operation. |
| | Alternatively, this can also be an RSSI measurement on the mmWave |
| | link. For instance, the RSSI measurement on the mmWave link can be |
| | above a threshold for the non-AP MLD to determine that mmWave link |
| | can be setup. |
| Signal to noise | According to one embodiment, this can be a SNR measurement on a sub- |
| ratio (SNR) | 6 GHz link. So, if the sub-6 GHz link has a strong SNR, then the non-AP |
| | MLD can determine that it can be within the connectivity range for the |
| | mmWave link operation. |
| | Alternatively, this can also be an SNR measurement on the mmWave |
| | link. For instance, the SNR measurement on the mmWave link can be |
| | above a threshold for the non-AP MLD to determine that mmWave link |
| | can be setup. |
| | Alternatively, this can also be an SINR value instead of SNR. |
| MCS index | According to one embodiment, this can be an MSC index being used for a |
| | sub-6 GHz link. So, if the MCS index is above a certain threshold, then |
| | the mmWave link can be used. |
| Data rate | According to one embodiment, this can be a data rate being used for a |
| | sub-6 GHz link. So, if the data rate is above a certain threshold, then the |
| | mmWave link can be used. |
| Beacon | According to one embodiment, the connectivity metric can be an |
| reception | indication of whether the beacon on the mmWave link can be received by |
| | the non-AP MLD or not. If the non-AP MLD can receive a beacon on the |
| | mmWave link then it can form a mmWave link. |

According to one embodiment, the connectivity metric can be measured on the AP MLD side. For example, uplink RSSI.

The AP MLD can report this value to the non-AP MLD to assist the non-AP MLD in setting up the mm Wave link.

The AP MLD can also recommend the non-AP MLD to setup a mmWave link when the measured value is greater than a certain threshold. For example, an AP MLD can transmit a BTM request frame or a link reconfiguration notify frame to recommend the mmWave link when the connectivity metric measured by the AP MLD for the sub-6 GHz link can be greater than a certain threshold.

According to one embodiment, the connectivity metric can be measured on the non-AP MLD side. For example, downlink RSSI.

The non-AP MLD can use this value to determine whether a mm Wave link can be setup or not. For example, non-AP MLD can transmit a link reconfiguration request frame to add the mm Wave link when the downlink RSSI on a sub-6 GHz link can be greater than a certain threshold.

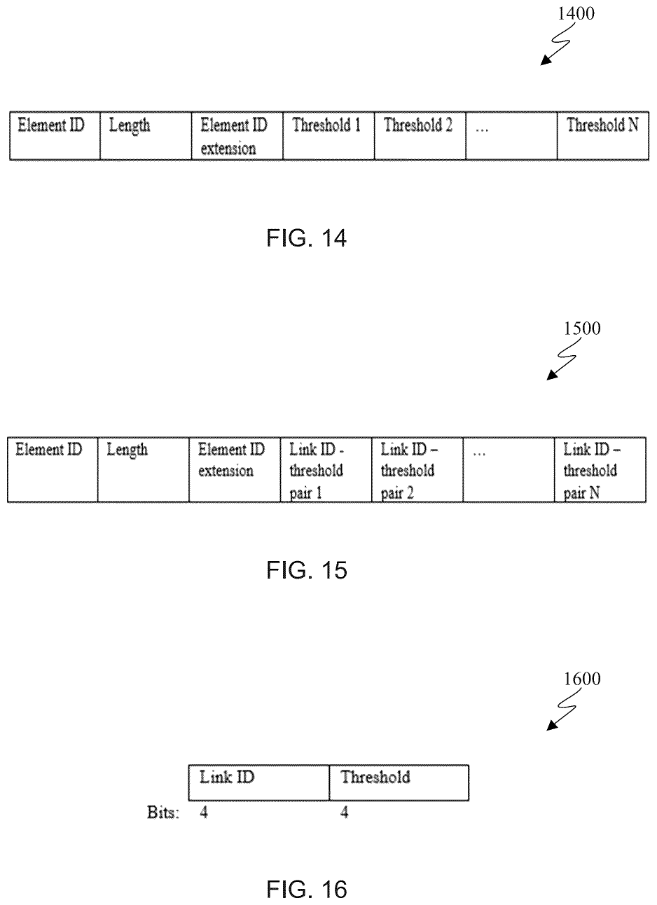

FIG. 14 illustrates an example element to advertise a connectivity threshold 1400 according to embodiments of the present disclosure. The embodiment of an example element to advertise a connectivity threshold of FIG. 14 is for illustration only. Different embodiments of an example element to advertise a connectivity threshold could be used without departing from the scope of this disclosure.

According to one embodiment, the connectivity thresholds can be different for different links.

According to one embodiment, the AP can advertise the connectivity thresholds. For example, there can be an element that can have an example format as shown in FIG. 14.

The thresholds can be arranged according to the link IDs. For example, threshold 1 corresponding to the lowest link ID on sub-6 GHz and threshold N corresponding to the highest link ID on sub-6 GHz.

FIG. 15 illustrates an example element to advertise a connectivity threshold for various links 1500 according to embodiments of the present disclosure. The embodiment of an example element to advertise a connectivity threshold for various links of FIG. 15 is for illustration only. Different embodiments of an example element to advertise a connectivity threshold for various links could be used without departing from the scope of this disclosure.

According to one embodiment, the AP can advertise the connectivity thresholds for various links. For example, there can be an element that can have an example format as shown in FIG. 15, where the thresholds can be arranged according to link ID threshold pairs.

FIG. 16 illustrates an example format for a link ID-threshold pair 1600 according to embodiments of the present disclosure. The embodiment of an example format for a link ID-threshold pair of FIG. 16 is for illustration only. Different embodiments of an example format for a link ID-threshold pair could be used without departing from the scope of this disclosure.

As shown in FIG. 16, the link ID threshold pair can be a pair of link ID and threshold for the link corresponding to that link ID. An example format can be as shown in FIG. 16.

According to one embodiment, the threshold can be advertised in beacons. For example, by including the element or its contents in a basic multi-link element. This can be advertised on all beacons of all the links or in the beacons of certain links.

According to one embodiment, the threshold can be provided to the non-AP MLD upon request. For example, a PV1 probe response option element in the probe request frame can indicate that the non-AP MLD is requesting for the above information and AP MLD can include the element in the probe response frame.

According to one embodiment, the threshold can be provided in an unsolicited manner by the AP MLD to the non-AP MLD.

According to one embodiment, the non-AP MLD can provide the above information to the AP MLD instead of receiving it from the AP MLD. The information can be provided upon request or in an unsolicited manner. For example, in (Re) association request frame.

The above information can also be included in a general element corresponding to mmWave operation.

According to one embodiment, an AP MLD can advertise the connectivity threshold information for a neighbor AP MLD. This can also be useful for non-AP MLD in making roaming related decisions.

According to one embodiment, an AP MLD can advertise the information for a neighbor AP MLD that is a part of a seamless roaming domain. For example, part of an SMD.

According to one embodiment, an AP MLD can advertise the information for a neighbor AP MLD that is a part of the same seamless roaming domain (e.g., SMD) as the reporting AP MLD.

According to one embodiment, an AP MLD can advertise the information for an AP MLD which may not be a neighbor AP MLD but a part of the same seamless roaming domain as the reporting AP MLD.

According to one embodiment, the above element can be included as a sub-element of neighbor report element.

The above information can be provided in an unsolicited manner. For example, beacons of the reporting AP MLD, modified RNR, unsolicited BTM request frame, etc.

The above information can be provided in a solicited manner. For example, the non-AP MLD can solicit the information via a BTM query, and the current AP MLD can provide the information in a BTM request frame.

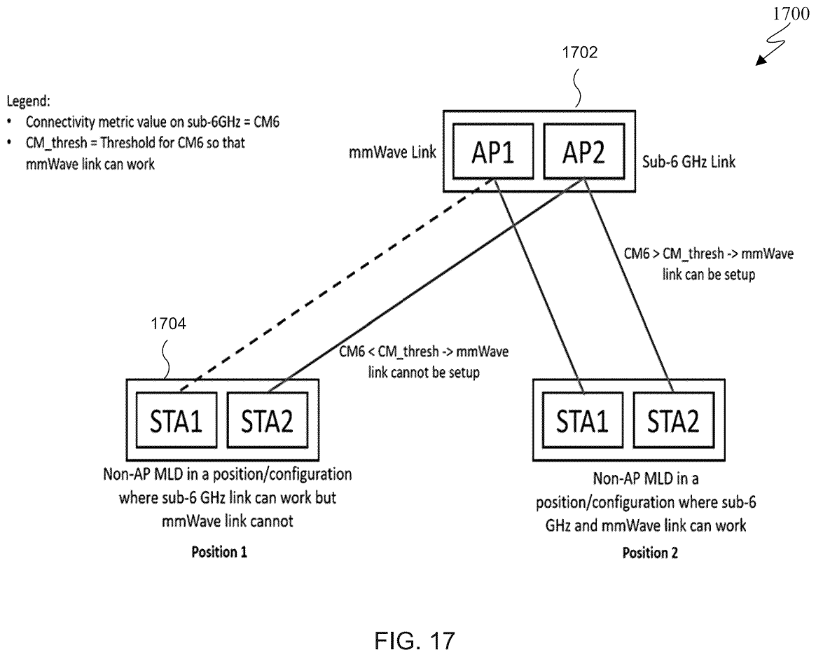

FIG. 17 illustrates an example restricted frame operation 1700 according to embodiments of the present disclosure. The embodiment of an example restricted frame operation of FIG. 17 is for illustration only. Different embodiments of an example restricted frame operation could be used without departing from the scope of this disclosure.

As shown in FIG. 17, an AP MLD 1702 has two links. The link with AP1 is a mm Wave link and the link with AP2 is a sub-6 GHz link. The non-AP MLD 1704 has two STAs-STA1 which can connect to the mmWave link and STA2 which forms a sub-6 GHz link. In position 1, the mm Wave link cannot be setup. For example, the non-AP MLD 1704 is not within the mm Wave coverage. In position 2, the mmWave link can be setup. For example, the non-AP MLD 1704 is within the mm Wave coverage.

Determination of whether the mm Wave link can be setup or not can be made based on a connectivity metric for the sub-6 GHz link. If the value for this connectivity metric is greater than (alternatively greater than or equal to) a certain threshold, then the non-AP MLD 1704 can setup the mmWave link with the AP MLD 1702. If the value for this connectivity metric is less than (alternatively less than or equal to) a certain threshold, then the non-AP MLD 1704 cannot setup mm Wave link with the AP MLD 1702.

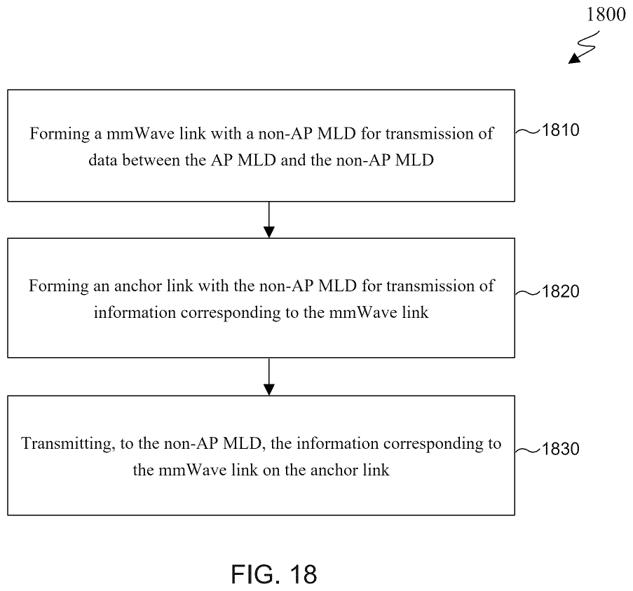

FIG. 18 illustrates an example method 1800 performed by an access point (AP) multi-link device (MLD) in a wireless communication system according to embodiments of the present disclosure. The method 1800 of FIG. 18 can be performed by any of the APs 101-103 of FIG. 1, such as AP 101 of FIG. 2A, and a corresponding method can be performed by any of the STAs 111-114 of FIG. 1, such as the STA 111 of FIG. 2B. The method 1800 is for illustration only and other embodiments can be used without departing from the scope of the present disclosure.

As illustrated in FIG. 18, the method 1800 begins at step 1810, where the AP MLD forms a millimeter wave (mmWave) link with a non-AP MLD for transmission of data between the AP MLD and the non-AP MLD. At step 1820, the AP MLD forms an anchor link with the non-AP MLD for transmission of information corresponding to the mmWave link. At step 1830, the AP MLD transmits, to the non-AP MLD, the information corresponding to the mm Wave link on the anchor link.

In some embodiments, the AP MLD configures the anchor link as a link that is common to each non-AP MLD that is associated with the AP MLD.

In some embodiments, the AP MLD configures the anchor link as a link that is a non-AP MLD specific link by: configuring one link of links of the non-AP MLD as the anchor link; or transmitting, to the non-AP MLD, a candidate anchor link list from which the non-AP MLD can choose the anchor link.

In some embodiments, the AP MLD configures the anchor link as a link that is common to some but not all non-AP MLDs that are associated with the AP MLD.

In some embodiments, the AP MLD transmits, to the non-AP MLD, information indicating which link is serving as the anchor link for the mmWave link.

In some embodiments, the AP MLD, during initial link setup: determines that the non-AP MLD intends to use the mm Wave link; and determines that the non-AP MLD is connected over the anchor link.

In some embodiments, the AP MLD, during link reconfiguration, determines that the non-AP MLD adding the mm Wave link has already connected over the anchor link or is adding the anchor link.

In some embodiments, the AP MLD, during link deletion, maintains at least one anchor link between the AP MLD and the non-AP MLD when the non-Ap MLD intends to maintain the mmWave link.

In some embodiments, the AP MLD, during an association procedure between the AP MLD and the non-AP MLD: receives, from the non-AP MLD, a request to setup the mmWave link and other links; and determines that at least one of the other links that the non-AP has requested to be setup is the anchor link.

In some embodiments, the AP MLD, during a link add procedure between the AP MLD and the non-AP MLD: receives, from the non-AP MLD, a request for a multi-link reconfiguration to add the mmWave link; determines that the request for the multi-link reconfiguration includes an indication to add the anchor link and an indication to add the mm Wave link; and accepts the request to add the mm Wave link.

In some embodiments, the AP MLD transmits, to the non-AP MLD, an advertisement message to advertise the anchor link, where the advertisement message includes information indicating at least one of an anchor link identifier, an anchor link indication, and an integrated mm Wave link indication.

The flowcharts herein illustrate example methods or processes that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method performed by an access point (AP) multi-link device (MLD), the method comprising:
forming a millimeter wave (mmWave) link with a non-AP MLD for transmission of data between the AP MLD and the non-AP MLD;
forming an anchor link with the non-AP MLD for transmission of information corresponding to the mmWave link; and
transmitting, to the non-AP MLD, the information corresponding to the mmWave link on the anchor link.

2. The method of claim 1, further comprising configuring the anchor link as a link that is common to each non-AP MLD that is associated with the AP MLD.

3. The method of claim 1, further comprising configuring the anchor link as a link that is a non-AP MLD specific link by:
configuring one link of links of the non-AP MLD as the anchor link; or
transmitting, to the non-AP MLD, a candidate anchor link list from which the non-AP MLD can choose the anchor link.

4. The method of claim 1, further comprising configuring the anchor link as a link that is common to some but not all non-AP MLDs that are associated with the AP MLD.

5. The method of claim 1, further comprising transmitting, to the non-AP MLD, information indicating which link is serving as the anchor link for the mm Wave link.

6. The method of claim 1, further comprising, during initial link setup:
determining that the non-AP MLD intends to use the mmWave link; and
determining that the non-AP MLD is connected over the anchor link.

7. The method of claim 1, further comprising, during link reconfiguration, determining that the non-AP MLD adding the mm Wave link has already connected over the anchor link or is adding the anchor link.

8. The method of claim 1, further comprising, during link deletion, maintaining at least one anchor link between the AP MLD and the non-AP MLD when the non-Ap MLD intends to maintain the mmWave link.

9. The method of claim 1, further comprising, during an association procedure between the AP MLD and the non-AP MLD:
receiving, from the non-AP MLD, a request to setup the mmWave link and other links; and
determining that at least one of the other links that the non-AP has requested to be setup is the anchor link.

10. The method of claim 1, further comprising, during a link add procedure between the AP MLD and the non-AP MLD:
receiving, from the non-AP MLD, a request for a multi-link reconfiguration to add the mmWave link;
determining that the request for the multi-link reconfiguration includes an indication to add the anchor link and an indication to add the mm Wave link; and
accepting the request to add the mmWave link.

11. The method of claim 1, further comprising transmitting, to the non-AP MLD, an advertisement message to advertise the anchor link, wherein the advertisement message includes information indicating at least one of an anchor link identifier, an anchor link indication, and an integrated mmWave link indication.

12. An electronic device comprising:
at least one processor including processing circuitry; and
memory storing instructions, wherein the instructions, when executed by the at least one processor individually or collectively, cause the electronic device to:
form a millimeter wave (mmWave) link with a non-access point (AP) multi-link device (MLD) for transmission of data between an AP MLD and the non-AP MLD;
form an anchor link with the non-AP MLD for transmission of information corresponding to the mmWave link; and
transmit, to the non-AP MLD, the information corresponding to the mm Wave link on the anchor link.

13. The electronic device of claim 12, wherein the instructions, when executed by the at least one processor individually or collectively, cause the electronic device to configure the anchor link as a link that is common to each non-AP MLD that is associated with the AP MLD.

14. The electronic device of claim 12, wherein the instructions, when executed by the at least one processor individually or collectively, cause the electronic device to configure the anchor link as a link that is a non-AP MLD specific link by causing the electronic device to:
configure one link of links of the non-AP MLD as the anchor link; or
transmit, to the non-AP MLD, a candidate anchor link list from which the non-AP MLD can choose the anchor link.

15. The electronic device of claim 12, wherein the instructions, when executed by the at least one processor individually or collectively, cause the electronic device to configure the anchor link as a link that is common to some but not all non-AP MLDs that are associated with the AP MLD.

16. The electronic device of claim 12, wherein the instructions, when executed by the at least one processor individually or collectively, cause the electronic device to transmit, to the non-AP MLD, information indicating which link is serving as the anchor link for the mmWave link.

17. The electronic device of claim 12, wherein the instructions, when executed by the at least one processor individually or collectively, cause the electronic device to, during initial link setup:
determine that the non-AP MLD intends to use the mmWave link; and
determine that the non-AP MLD is connected over the anchor link.

18. The electronic device of claim 12, wherein the instructions, when executed by the at least one processor individually or collectively, cause the electronic device to, during link reconfiguration, determine that the non-AP MLD adding the mmWave link has already connected over the anchor link or is adding the anchor link.

19. The electronic device of claim 12, wherein the instructions, when executed by the at least one processor individually or collectively, cause the electronic device to, during link deletion, maintain at least one anchor link between the AP MLD and the non-AP MLD when the non-AP MLD intends to maintain the mmWave link.

20. The electronic device of claim 12, wherein the instructions, when executed by the at least one processor individually or collectively, cause the electronic device to, during an association procedure between the AP MLD and the non-AP MLD:
receive, from the non-AP MLD, a request to setup the mmWave link and other links; and
determine that at least one of the other links that the non-AP MLD has requested to be setup is the anchor link.
